(19) United States
(12) Patent Application Publication
(10) Pub. No.: US 2015/0296043 A1
(43) Pub. Date: Oct. 15, 2015

(54) DYNAMIC IDENTIFICATION SYSTEM AND METHOD FOR IoT DEVICES

(71) Applicant: SMARTY LAB CO., LTD., Seoul (KR)

(72) Inventors: Soo Dong KIM, Seoul (KR); Hyun Jung LA, Seoul (KR)

(21) Appl. No.: 14/681,353

(22) Filed: Apr. 8, 2015

(30) Foreign Application Priority Data
Apr. 15, 2014 (KR) 10-2014-0045027

(51) Int. Cl. H04L 29/08; H04L 29/06

(52) U.S. Cl. CPC H04L 67/303; H04L 67/42; H04L 67/16

(57) ABSTRACT

Disclosed herein is a system and method for dynamically identifying devices in an Internet of things environment configured such that devices and an IoT application server are connected based on the Internet. The system includes devices, each having a profile distribution component for transmitting a profile thereof to an IoT application server; and the IoT application server for identifying, managing, and connecting each device, wherein the IoT application server includes a device pool manager for receiving a profile from the device, storing the profile in an active device pool, and managing the profile of the device; an active device pool for storing the profile; and an IoT service unit for receiving notification that a new device has been discovered from the device pool manager, and dynamically checking discovery of the new device by scanning the active device pool for a profile of each device at a predetermined time.

### BACKGROUND OF THE INVENTION

1. Field of the Invention

The present invention generally relates to a system and method for dynamically identifying devices in an Internet of things environment and, more particularly, to a system and method for dynamically identifying devices in an Internet of things environment that is configured such that devices and an Internet of things application server are connected to each other based on the Internet.

2. Description of the Related Art

Generally, the Internet of Things denotes intelligent technology and service for mutually exchanging information between a human being and a thing and between individual things by connecting all things over the Internet. The Internet of Things is also known by the acronym ‘IoT’.

Such an Internet of things is a further evolved stage of existing wired communication-based Internet or mobile Internet, and is characterized in that devices connected to the Internet process information by mutually exchanging the information with each other without the intervention of human beings. The Internet of things is similar to existing ubiquitous or Machine to Machine (M2M) communication in that things communicate with each other without depending on a human being. However, the Internet of things may be regarded as a stage evolving into interaction with all pieces of information in the real world and the virtual world, as well as things, by extending the concept of M2M to the Internet.

Technical elements for implementing the Internet of things include sensing technology for acquiring information from visible things and a surrounding environment, wired/wireless communication and network infrastructure technology for supporting things so that the things are connected to the Internet, service interface technology for handling and processing information in conformity with various service areas and types or for merging various types of technologies, and security technology for preventing hacking of components in the Internet of things, such as a large amount of data, or information leakage.

However, since Internet of Things (IoT) devices have mobility, various technologies for dynamically identifying devices in consideration of dynamic characteristics of the devices have been developed.

As conventional technology, a passive device identification method and an active device identification method are currently used.

Here, a passive device identification method is configured such that a certain device sends its own identification information when a request for identification information is received from an additional device in an IoT environment, and such that a server for monitoring a network environment periodically sends an identification information request message so as to identify a device that newly enters the network. This method is advantageous in that the network monitoring server periodically sends an identification information request, and thus a device overhead required for identification is low. However, such a method is problematic in that a device is not identified until an identification information request message is received from the monitoring server, and thus real-time identification is not performed.

Further, an active device identification method is configured such that, when a certain device in an Internet of things environment enters a network, the device sends its own identification information to an additional device or a server in the same network. The additional device or server that receives the identification information sends an acknowledgement (ACK) message to the certain device, thus completing identification of the device. If an ACK message is not received, the certain device periodically sends its own identification information until it receives an ACK message. This method is advantageous in that a device that newly enters the network can be identified in real time, but is problematic in that the consumption of limited resources of the device may be increased.

In addition, the conventional technologies dynamically identify devices connected to the network, but they are dependent on the physical layer of a network protocol, such as Ad-hoc or WiFi protocol, and are merely focused on a situation in which a device newly enters a network, thus making it impossible to even consider a situation in which a device deviates from the network.

### PRIOR ART DOCUMENTS

### Non-Patent Documents

(Non-patent Document 1) S. I. Ahamed M. Zulkernine, and S. Anamanamuri, “A Dependable Device Discovery Approach for Pervasive Computing Middleware”, In Proceedings of the 1st International Conference on Availability, Reliability, and Security, April 2006.
(Non-patent Document 2) Takaaki Tanaka, Shinichiro Moriwaki, and Kenichi Ooto, “Applying Device Discovery Methods for Home Network Management”, In Proceedings of 2010 8th Asia-Pacific Symposium on Information and Telecommunication Technologies (APSITT), pp. 1-6, 2010, June 2010.
(Non-patent Document 3) Ehsan Ullah Warriach, Eirini Kaldeli, Jaap Bresser, Alexander Lazovik, and Marco Aiello, “Heterogeneous Device Discovery Framework for The Smart Homes”, In Proceedings of GCC Conference and Exhibition, February 2011.

### SUMMARY OF THE INVENTION

Accordingly, the present invention has been made keeping in mind the above problems occurring in the prior art, and an object of the present invention is to provide a system and method for dynamically identifying devices in an Internet of things environment, which detect in real time a new device entering a network or a previously entered device deviating from the network in the Internet of things (IoT) environment, thus dynamically identifying an IoT device having mobility and also dynamically detecting an IoT device deviating from the network due to the movement of the device or the depletion of limited resources of a battery.

Another object of the present invention is to effectively discover a device that newly enters a network, without being dependent on a network protocol via interaction between devices and a server, and to reduce a device overhead because the device is discovered by scanning for the profile of each device only when an IoT service is required.

A further object of the present invention is to determine whether each device is in an idle state and to check the state of a network only for a device in the idle state, thus reducing the number of devices, for which the state of the network is to be checked, compared to a case where the state of a network is checked for profiles of all devices stored in an active device pool, with the result that the network state can be promptly detected.

In order to accomplish the above objects, the present invention provides a system for dynamically identifying devices in an Internet of things (IoT) environment configured such that devices and an IoT application server are connected to each other based on Internet, including one or more devices, each having a profile distribution component for transmitting a profile thereof to an IoT application server; and the IoT application server for identifying, managing, and connecting each device, wherein the IoT application server includes a device pool manager for receiving a profile from a device, storing the profile in an active device pool, and managing the stored profile of the device; an active device pool for storing the profile of the device received from the profile distribution component of the device; and an IoT service unit for receiving notification that a new device has been discovered from the device pool manager, and dynamically checking discovery of the new device by scanning the active device pool for a profile of each device at a predetermined time.

Further, the device pool manager may calculate a difference between a final time at which the device is connected and used and a current time, determine that the device is in an idle state if the difference is greater than a preset reference value, check, based on the profile of the device determined to be in the idle state, a network state of the device via exchange of messages with the device, and manage a profile of an available device by removing a profile of the corresponding device from the active device pool when a fault occurs in the network state of the device.

Further, the present invention provides a method for dynamically identifying devices in an Internet of things (IoT) environment configured such that devices and an IoT application server are connected to each other based on Internet, including by a profile distribution component provided in each device, transmitting a profile thereof to an IoT application server; by a device pool manager provided in the IoT application server, receiving a profile from a device, and storing the profile in an active device pool provided in the IoT application server; by the device pool manager, notifying an IoT service unit provided in the IoT application server that a new device has been discovered; and by the IoT service unit, dynamically checking discovery of the new device by scanning the active device pool for a profile of each device at a predetermined time.

In addition, the method of the present invention may further include, by the device pool manager, calculating a difference between a final time at which the device is connected and used and a current time, and determining that the device is in an idle state if the difference is greater than a preset reference value; by the device pool manager, checking, based on the profile of the device determined to be in the idle state, a network state of the device via exchange of messages with the device; and by the device pool manager, managing a profile of an available device by removing a profile of the corresponding device from the active device pool when a fault occurs in the network state of the device.

Accordingly, the present invention may detect in real time a new device entering a network or a previously entered device deviating from the network in the Internet of things (IoT) environment, thus dynamically identifying an IoT device having mobility and also dynamically detecting an IoT device deviating from the network due to the movement of the device or the depletion of limited resources of a battery.

Further, the present invention may effectively discover a device that newly enters a network, without being dependent on a network protocol via interaction between devices and a server, and may reduce a device overhead because the device is discovered by scanning for the profile of each device only when an IoT service is required.

Furthermore, the present invention may determine whether each device is in an idle state and to check the state of a network only for a device in the idle state, thus reducing the number of devices, for which the state of the network is to be checked, compared to a case where the state of a network is checked for profiles of all devices stored in an active device pool, with the result that the network state can be promptly detected.

### BRIEF DESCRIPTION OF THE DRAWINGS

The above and other objects, features and advantages of the present invention will be more clearly understood from the following detailed description taken in conjunction with the accompanying drawings, in which:

FIG. 1A and FIG. 1B are diagrams showing the configuration of a system for dynamically identifying devices in an Internet of things environment according to the present invention;

FIG. 2A is a flowchart showing a method for dynamically identifying devices in an Internet of things environment according to the present invention, and FIG. 2B is a flowchart showing a method for detecting a device deviating from a network in an Internet of things environment according to the present invention;

FIG. 3 is a diagram showing an algorithm for dynamically detecting the network state of a device in an Internet of things environment according to the present invention; and

FIG. 4 is a schematic diagram showing a state in which a device deviates from a network according to the present invention.

### DESCRIPTION OF THE PREFERRED EMBODIMENTS

Hereinafter, embodiments of the present invention will be described in detail with reference to the attached drawings.

A system for dynamically identifying devices in an Internet of things environment according to the present invention is configured such that Internet of Things (IoT) devices 10 having network/Internet ability and an IoT application server 20 are connected to each other based on the Internet, and is intended to dynamically detect an IoT device 10 newly entering the network or a previously entered IoT device deviating from the network, in consideration of the dynamic characteristics of each IoT device 10.

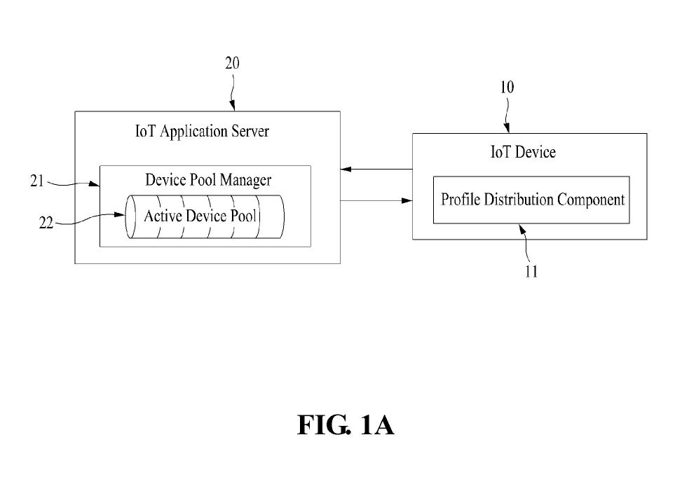

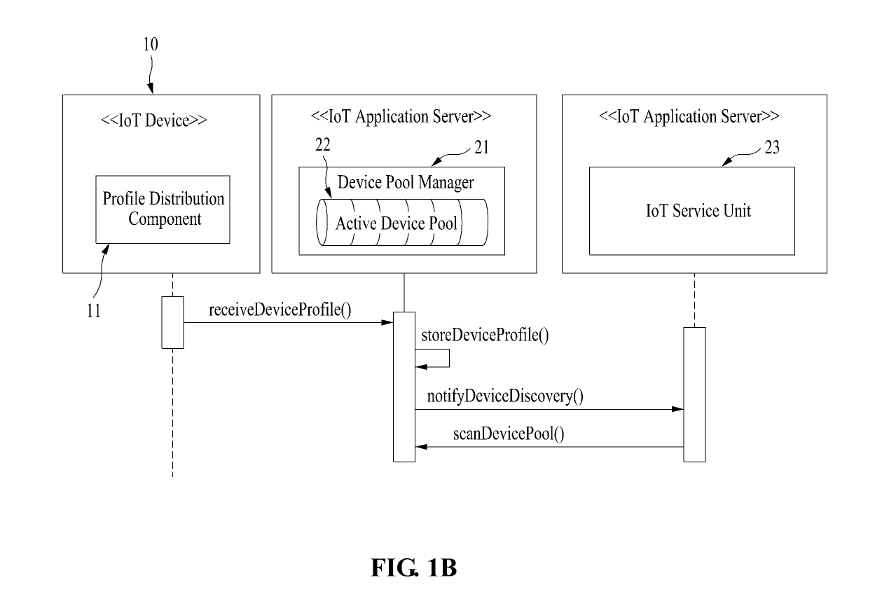

As shown in the configuration diagram of FIG. 1A and FIG. 1B, the IoT device 10 includes a profile distribution component 11, which transmits the profile of its own device 10 to the IoT application server 20.

The IoT application server 20 identifies the device 10, manages the removal or the like of the profile of the device 10, and is connected to the device 10.

Further, the IoT application server 20 includes a device pool manager 21 for receiving a profile from each device 10, stores it in an active device pool 22, and managing the stored profile of the device 10; the active device pool 22 for storing the profile of the device 10 received from the profile distribution component 11 of the device 10; and an IoT service unit 23 for receiving notification that a new device 10 has been discovered from the device pool manager 21, scanning the active device pool 22 for the profile of the corresponding device 10 at a predetermined desired time, and dynamically checking the discovery of the new device 10.

In this case, the device pool manager 21 calculates a difference between a final time at which the device 10 is connected and used and a current time, and determines that the device 10 is in an idle state if the difference is greater than a preset reference value. Further, based on the profile of the device 10 determined to be in the idle state in this way, the device pool manager 21 determines the network state of the device, that is, whether the device 10 has entered the network or deviated from the network, via the exchange of messages with the device 10. If a fault occurs in the network state of the device 10, the device pool manager 21 manages the profiles of available devices in such a way as to remove the profile of the corresponding device 10 from the active device pool 22.

Below, a method for dynamically identifying devices in an Internet of things environment according to the present invention will be described in detail with reference to the attached drawings. This relates to a method for dynamically identifying devices in an Internet of things environment configured such that each device (IoT device) 10 and the IoT application server 20 are connected to each other based on the Internet.

As shown in FIG. 1A and FIG. 1B, the IoT device 10 includes the profile distribution component 11 for, when entering and participating in the network, transmitting its own profile to the IoT application server 20. The IoT application server 20 includes the active device pool 22 for storing the profile of the device 10 that enters and participates in the network, and the device pool manager 21 for managing the active device pool 22.

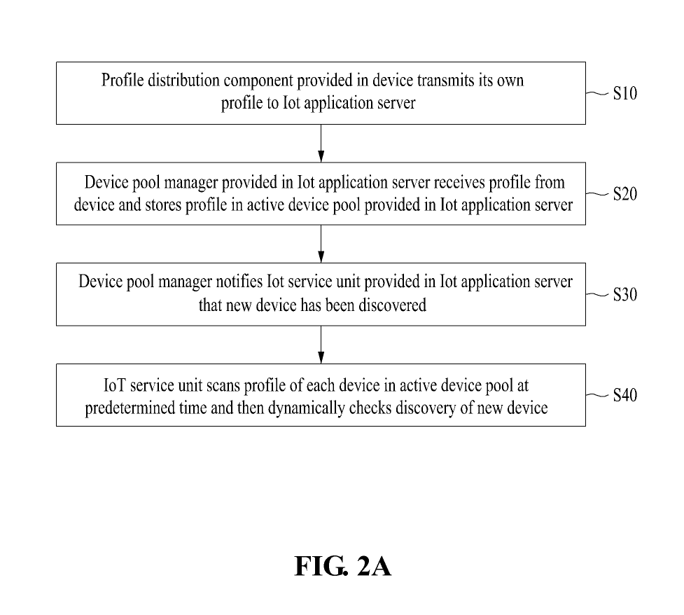

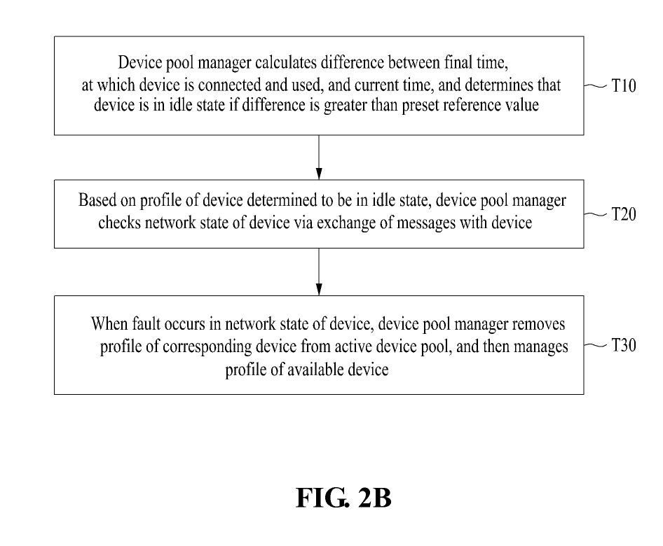

Referring to FIG. 2A, in the method for dynamically identifying devices in an Internet of things environment according to the present invention, when the IoT device 10 enters the network, is connected to the network, and becomes usable, the profile distribution component 11 provided in the device 10 transmits its own profile to the device pool manager 21 of the IoT application server 20 at step S10.

Next, the device pool manager 21 provided in the IoT application server 20 stores the profile received from the profile distribution component 11 of the device 10 in the active device pool 22 of the IoT application server 20 at step S20.

In this way, the active device pool 22 contains the profile of each available device among devices 10 discovered in the network.

Here, the device pool manager 21 notifies the IoT service unit 23 of the IoT application server 20 that a new device 10 has been discovered at step S30.

Further, the IoT service unit 23 scans the active device pool 22 for the profile of each device 10 at a predetermined desired time and then dynamically checks the discovery of the new device 10 at step S40.

The profile of the newly discovered device 10 is used when the IoT application server 20 requests a connection to the corresponding device 10 in order to connect to and use the device.

In this way, the device pool manager 21 may effectively discover a device that newly enters the network, without being dependent on a network protocol via interaction between the device 10 and the IoT application server 20, and the IoT service unit 23 checks a newly entered device 10 by scanning for the profile of each device only at a desired time rather than discovering a new device 10 whenever the profile of each device 10 is transmitted, thus reducing an overhead.

Meanwhile, the method for dynamically identifying devices in an Internet of things environment according to the present invention may include a method for promptly detecting a device 10 deviating from the network with a shorter delay time when the IoT application server 20 utilizes the profile information of the device 10.

Referring to FIG. 2B, at step T10, the device pool manager 21 of the IoT application server 20 calculates a difference between a final time, at which the device 10 is connected and used, and a current time, and determines that the corresponding device 10 is in an idle state if the difference is greater than a preset reference value.

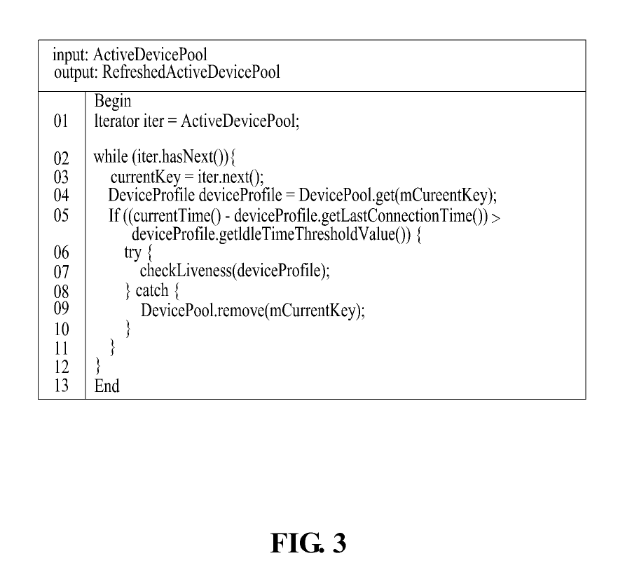

In an algorithm illustrated in FIG. 3, lines 01 to 04 denote syntax elements for scanning the active device pool 22 of the IoT application server 20 for the profiles of all devices 10 stored in the pool, and step T10 corresponds to line 05 in the algorithm of FIG. 3.

This operation shows that a device 10, which has not been recently used and was used a long while ago, is determined to be in the idle state, and that a device 10, which has recently been used, is determined to be in a valid network state.

Next, based on the profile information of the device 10 determined to be in an idle state, the device pool manager 21 checks the network state of the device 10 via the exchange of messages with the device 10 at step T20.

That is, the recently used device 10 is determined to be in a valid network state, and the network state thereof is not additionally checked. Therefore, as shown in line 07 of the algorithm of FIG. 3, the network state of only a device 10 determined to be in an idle state is checked, based on the profile information of the device 10.

Here, when a fault occurs in the network state of the device 10, the profile of the device 10 is removed by the device pool manager 21 from the active device pool 22, and then the profile of an available device 10 is managed at step T30. This step is shown in line 09 in the algorithm of FIG. 3.

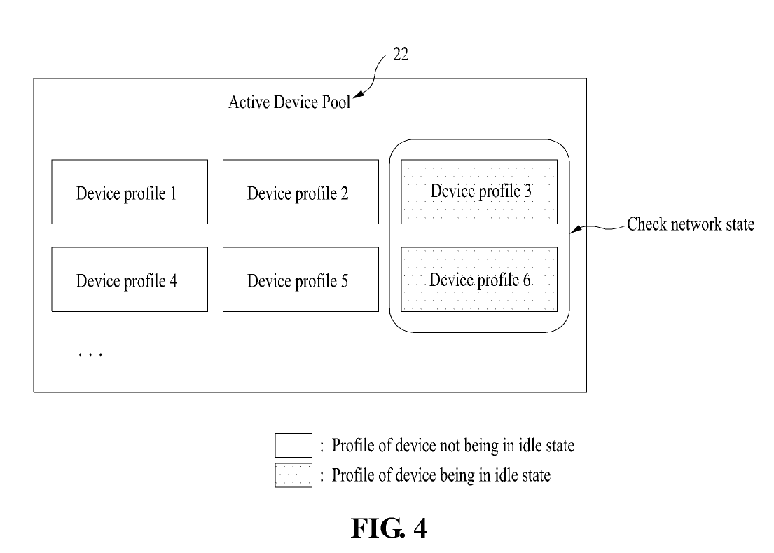

In this way, as illustrated in the schematic diagram of FIG. 4 showing the state in which a device deviates from the network according to the present invention, the idle state of the device 10 is determined, and the network state of only the device 10 in the idle state is checked. As a result, the number of devices 10, the network state of which is to be checked, may be reduced, compared to a case where the network states of all devices stored in the active device pool 22 are checked based on the profiles of all the devices, thus promptly determining the network states of devices.

Consequently, the system and method for dynamically identifying devices in an Internet of things environment according to the present invention may detect in real time a new device entering a network or a previously entered device deviating from the network in the Internet of things (IoT) environment, thus dynamically identifying an IoT device having mobility and also dynamically detecting an IoT device deviating from the network due to the movement of the device or the depletion of limited resources of a battery. Further, the present invention may effectively discover a device that newly enters a network, without being dependent on a network protocol via interaction between devices and a server, and may reduce a device overhead because a device is discovered by scanning for the profile of each device only when an IoT service is required. Furthermore, the present invention may determine whether each device is in an idle state and to check the state of a network only for a device in the idle state, thus reducing the number of devices, for which the state of the network is to be checked, compared to a case where the state of a network is checked for profiles of all devices stored in an active device pool, with the result that the network state can be promptly detected.

As described above, although the present invention has been described in detail with reference to preferred embodiments of the present invention, the scope of the present invention is not limited to specific embodiments, and should be interpreted by the accompanying claims. Further, it is apparent that those skilled in the art may practice various modifications and applications, without departing from the scope and spirit of the present invention.

What is claimed is:

1. A system for dynamically identifying devices in an Internet of things (IoT) environment configured such that devices and an IoT application server are connected to each other based on Internet, comprising:
one or more devices, each having a profile distribution component for transmitting a profile thereof to an IoT application server; and
the IoT application server for identifying, managing, and connecting each device;
wherein the IoT application server comprises:
a device pool manager for receiving a profile from the device, storing the profile in an active device pool, and managing the stored profile of the device;
an active device pool for storing the profile of the device received from the profile distribution component of the device; and
an IoT service unit for receiving notification that a new device has been discovered from the device pool manager, and dynamically checking discovery of the new device by scanning a profile of each device in the active device pool at a predetermined time,
wherein the device pool manager calculates a difference between a final time at which the device is connected and used and a current time, determines that the device is in an idle state if the difference is greater than a preset reference value, checks, based on the profile of the device determined to be in the idle state, a network state of the device via exchange of messages with the device, and manages a profile of an available device by removing a profile of the corresponding device from the active device pool when a fault occurs in the network state of the device.

2. A method for dynamically identifying devices in an Internet of things (IoT) environment configured such that devices and an IoT application server are connected to each other based on Internet, comprising:
by a profile distribution component provided in each device, transmitting a profile thereof to an IoT application server;
by a device pool manager provided in the IoT application server, receiving a profile from a device, and storing the profile in an active device pool provided in the IoT application server;
by the device pool manager, notifying an IoT service unit provided in the IoT application server that a new device has been discovered;
by the IoT service unit, dynamically checking discovery of the new device by scanning a profile of each device in the active device pool at a predetermined time;
by the device pool manager, calculating a difference between a final time at which the device is connected and used and a current time, and determining that the device is in an idle state if the difference is greater than a preset reference value;
by the device pool manager, checking, based on the profile of the device determined to be in the idle state, a network state of the device via exchange of messages with the device; and
by the device pool manager, managing a profile of an available device by removing a profile of the corresponding device from the active device pool when a fault occurs in the network state of the device.
